(19) United States
(12) Patent Application Publication
(10) Pub. No.: US 2025/0283553 A1
(43) Pub. Date: Sep. 11, 2025

(54) PUSH-PULL VALVE

(71) Applicant: AEROJET ROCKETDYNE, INC., Melbourne, FL (US)

(72) Inventors: Arturo Tolentino, Redmond, WA (US); Michael Baumgartner, Los Angeles, CA (US); Kevin Matsuno, Moorpark, CA (US)

(21) Appl. No.: 18/861,333

(22) PCT Filed: May 4, 2022
(86) PCT No.: PCT/US2022/027569

§ 371 Date: Oct. 29, 2024

(51) Int. Cl. F16K 31/08; F02K 9/97

(52) U.S. Cl. CPC F16K 31/082; F02K 9/978

(57) ABSTRACT

A valve includes a valve body that has a flow path that connects the inlet and the outlet. A seal is disposed in the flow path. The seal has a closed state so as to block flow through the flow path and an open state so as to permit flow through the flow path. An armature is disposed in the valve body and is moveable with respect to the seal. An electromagnet is configured to selectively receive an electric current in a first current direction or a second, opposite current direction. When the electric current is in the first current direction the electromagnet actuates the armature to move the seal from closed to open and when the electric current is in the second current direction the electromagnet magnetically actuates the armature to move the seal from the open to closed.

### BACKGROUND

Valves are ubiquitous in systems that handle fluids. One example is in a motor to control fuel flow for combustion. Such valves may include a valve armature that carries a valve member that seals against a valve seat. A spring may bias the armature to a closed position in which the valve member is seated in the valve seat so as to block flow. A solenoid coil serves as an actuator. When electric current is provided to the coil, a magnetic field is generated that causes the armature to move against the spring force and thereby lift the valve member off of the valve seat to permit flow. Once power to the solenoid is turned off, the spring moves the armature back to the closed position.

### SUMMARY

A valve according to an example of the present disclosure includes a valve body that has a flow path, and a seal disposed in the flow path. The seal has a default closed state sealed against a seal seat so as to block flow through the flow path and an open state separated from the seal seat so as to permit flow through the flow path. An armature is disposed in the valve body and is moveable with respect to the seal. An electromagnet is configured to selectively receive an electric current in a first current direction or a second, opposite current direction. When the electric current is in the first current direction the electromagnet actuates the armature to move the seal from the closed state to the open state, and when the electric current is in the second current direction the electromagnet actuates the armature to move the seal from the open state to the closed state.

In a further embodiment of any of the foregoing embodiments, the electromagnet includes first and second coil windings that are oppositely wound.

In a further embodiment of any of the foregoing embodiments, the armature includes a rod portion, a yoke comprised of a permanent magnet and a keeper that surrounds the permanent magnet, and a shell that encases the yoke.

In a further embodiment of any of the foregoing embodiments, the rod portion has a tip that is in contact with the seal.

In a further embodiment of any of the foregoing embodiments, the shell is non-ferromagnetic and is formed of a titanium-based alloy.

In a further embodiment of any of the foregoing embodiments, the seal is an elastomer.

In a further embodiment of any of the foregoing embodiments, the shell is a material selected from the group consisting of titanium-based alloy, aluminum-based alloy, and polymer.

In a further embodiment of any of the foregoing embodiments, when the electric current is in the first current direction the electromagnet magnetically pushes the rod portion to apply force on the seal and thereby move the seal from the closed state to the open state and when the electric current is applied in the second current direction the electromagnet magnetically pulls the rod portion to remove the force on the seal and thereby move the seal from the open state to the closed state.

In a further embodiment of any of the foregoing embodiments, the force causes a portion of the seal to deflect and lift off of the seal seat so as to open the flow through the flow path.

A further embodiment of any of the foregoing embodiments includes controller connected with the electromagnet and configured to selectively apply the electric current in the first direction or the second direction.

In a further embodiment of any of the foregoing embodiments, the controller is configured to apply the electric current in the second current direction for a preset amount of time to move the seal from the open state to the closed state.

A valve according to an example of the present disclosure includes a valve body that has a flow path, and a seal disposed in the flow path. The seal has a default closed state sealed against a seal seat so as to block flow through the flow path and an open state in which the seal permits flow through the flow path. An armature is disposed in the valve body. An electromagnet is configured to magnetically push the armature to apply force on the seal and thereby move the seal from the closed state to the open state. The force causes a portion of the seal to deflect and thereby separate from the seal seat so as to open the flow through the flow path.

In a further embodiment of any of the foregoing embodiments, the electromagnet includes first and second coil windings that are oppositely wound, and the armature includes a rod portion, a yoke comprised of a permanent magnet and a keeper that surrounds the permanent magnet, and a shell that encases the yoke.

In a further embodiment of any of the foregoing embodiments, the rod portion has a distal tip that is in contact with the seal and the seal is an elastomer.

In a further embodiment of any of the foregoing embodiments, the shell is non-ferromagnetic and is formed of a titanium-based alloy.

In a further embodiment of any of the foregoing embodiments, the shell is a material selected from the group consisting of titanium-based alloy, aluminum-based alloy, and polymer.

In a further embodiment of any of the foregoing embodiments, the electromagnet is configured to selectively receive electric current in a first current direction or a second, opposite current direction, wherein when the electric current is in the first current direction the electromagnet magnetically pushes the armature to apply the force on the seal and when the electric current is in the second current direction the electromagnet magnetically pulls the armature to reduce the force on the seal. The reduction in force causes the portion of the seal to move and thereby seat on the seal seat so as to close the flow through the flow path.

A rocket motor according to an example of the present disclosure includes a propellant tank holding propellant, a combustor, a nozzle attached with the combustor, a supply line that fluidly connects the propellant tank and the combustor, and a valve according to any of the foregoing embodiments situated in the supply line.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example of a rocket motor.

FIG. 2 illustrates a valve of the rocket motor in a closed state.

FIG. 3 illustrates a valve of the rocket motor in an open state.

FIG. 4 illustrates a valve with magnetic field lines.

FIG. 5 illustrates a region of the seal of the valve in a closed state.

FIG. 6 illustrates a region of the seal of the valve in an open state.

FIG. 7 illustrates a sectioned view through the seal of the valve.

FIG. 8 illustrates a valve in a latched state.

### DETAILED DESCRIPTION

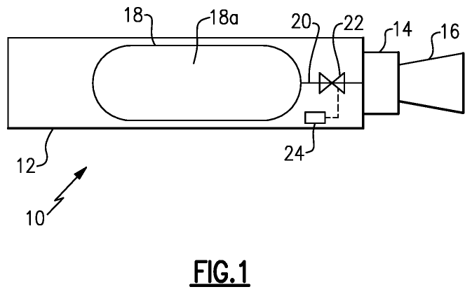

FIG. 1 illustrates a rocket motor 10 to demonstrate example aspects of a valve that is disclosed herein. It is to be appreciated, however, that applications other than a rocket motor will also benefit from this disclosure.

The rocket motor 10 generally includes a rocket motor body 12, a combustor 14, a nozzle 16 attached with the combustor 14, a propellant tank 18 holding a propellant 18a, and a supply line 20 that connects propellant tank 18 with the combustor 14. There is a valve 22 in the supply line 20 and a controller 24 in communication with the valve 22 to control the operation thereof, namely control of the flow of the propellant 18a to the combustor 14. As will be appreciated, the rocket motor 10 will contain additional componentry that is beyond the scope of this disclosure.

FIG. 2 illustrates a sectioned view of an example of the valve 22. The valve 22 includes a valve body 26 that has an inlet 26a, an outlet 26b and a flow path P that connects the inlet 26a to the outlet 26b. The valve body 26 may be formed of a single, unitary piece or multiple pieces that are secured to one another so as to bound the flow path P or a portion thereof.

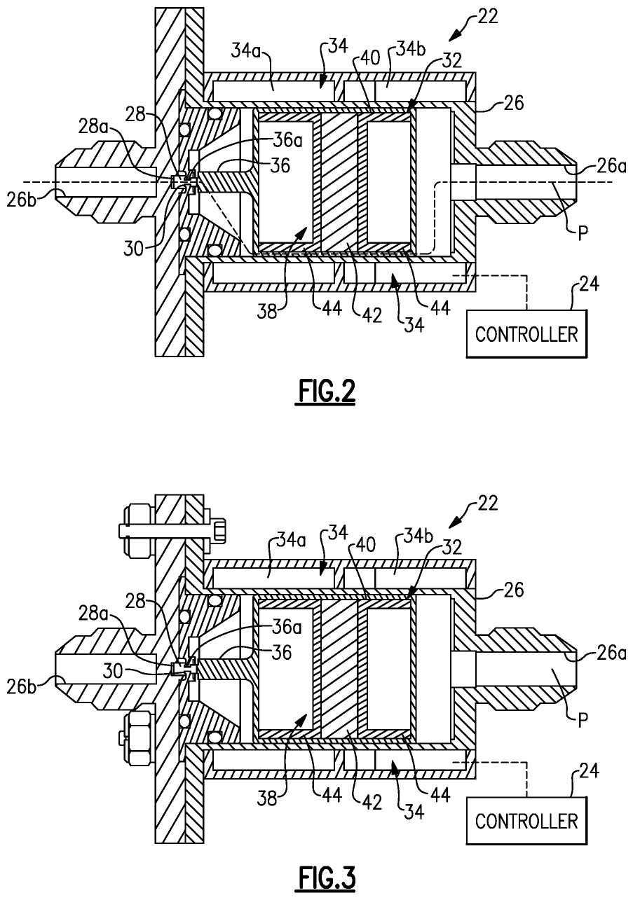

The valve 22 further includes a seal 28 that is disposed in an outlet cavity 28a along a portion of the flow path P. For example, the seal 28 is an elastomer that maintains good properties in the fluid that is to be conveyed through the valve 22. In a rocket motor that utilizes hydrazine as the propellant 18a, the elastomer may be ethylene propylene terpolymer. One example is known under the tradename AF-E-411 (Parker Hannifin), but other elastomers may be used as well. In FIG. 2, the seal 28 is in a default closed state in which it is sealed against a seal seat 30 so as to block flow through the flow path P. When the seal 28 is separated from the seal seat 30 (FIG. 3), flow is permitted through the flow path P.

The valve 22 also includes an armature 32 and an electromagnet 34. The armature 32 is disposed in the valve body 26 and is moveable with respect to the seal 28. The electromagnet 34 is connected to the controller 24 and includes first and second coil windings 34a/34b that are oppositely wound. The coil windings 34a/34b are connected in series. For example, there is a single continuous wire that has a portion that is wound in one direction to form the first coil winding 34a and another portion that is wound in the opposite direction to form the second coil winding 34b. The controller 24 may include hardware, software, or both, that are configured and/or programmed to carry out the functions herein with respect to control of the valve 22. Hardware may include, but is not limited to, a micro-processor module, circuitry, control logic, memory module, and/or a power source.

The armature 32 is made up of several sub-components, including a rod portion 36, a yoke 38, and a shell 40 that encases the yoke 38 and prevents the fluid in the valve 22 from contacting the yoke 38. The yoke 38 is comprised of a permanent magnet 42 and a keeper 44 that surrounds the permanent magnet 42. The keeper 44 is made of a magnetic material. The rod portion 36 has a tip 36a that is in contact with the seal 28, the function of which will be described in further detail below.

The fluid that is intended to be conveyed through the valve 22 may not be compatible with the materials used in the yoke 38. For instance, the fluid may accelerate corrosion of the material. As a non-limiting example in the rocket motor 10, if hydrazine is to be used as the propellant 18a, it may be desirable to avoid contact with stainless steel (e.g., the keeper 44) and magnet. In this regard, the shell 40 hermetically encases the yoke 38 and thereby prevents the fluid from coming into contact with the sub-components of the yoke 38. In one example, the shell 40 is a cladding that is applied around the yoke 38. In other examples, the shell 40 may be a configuration of pre-fabricated pieces that are bonded to one another to encase the yoke 38.

The shell 40 may be formed of a non-ferromagnetic material (not attracted to magnets) so as to avoid substantial interference with the magnetic fields of the permanent magnet 42 and the electromagnet 34. For example, the material is selected from titanium-based alloy, aluminum-based alloy, or polymer. Other non-ferromagnetic alloys may also be used, such as non-magnetic nickel alloys (e.g., Inconel 625).

The material selected for the shell 40 is compatible with the fluid that is to be conveyed through the valve 22, at least by comparison to one or more materials of the sub-components of the yoke 38. Additionally, with the benefit of this disclosure one of ordinary skill in the art will recognize that the selected material will also have other strength and durability characteristics to meet the design requirements of the particular implementation. For instance, aluminum alloy has good strength, durability, and corrosion resistance, and titanium alloy has excellent strength, durability, and corrosion resistance. Polymer may also be used for ease of manufacturing and chemical resistance but is generally not as strong as titanium or aluminum alloys.

In the operation of the valve 22, the electromagnet 34 selectively receives an electric current in a first current direction or a second, opposite current direction. As indicated above, the controller 24 serves to operate the valve 22 and thus control the direction and magnitude of electric current. When the electric current is applied in the first current direction, the electromagnet 34 magnetically actuates the armature 32 to move the seal 28 from the default closed state (FIG. 1) to the open state (FIG. 2). When the electric current is applied in the second current direction the electromagnet 34 magnetically actuates the armature 32 to move the seal 28 from the open state to the closed state. As will be appreciated, the closed state is the default ready position in the illustrated examples, but a different default position could be used, such as a default ready open position or latched inactive condition.

FIG. 4 illustrates a sectioned view of the valve 22 with magnetic field lines L1 that represent the magnetic fields generated by permanent magnet 42. The electrical fields generated by the coil portions 34a/34b of the electromagnet 34 cross the magnetic field of the permanent magnet 42. By this interaction, the polarity, strength, and timing of the electrical fields generated by the electromagnet 34 operate to manipulate the magnetic field of the permanent magnet 42 to open and close the seal 28.

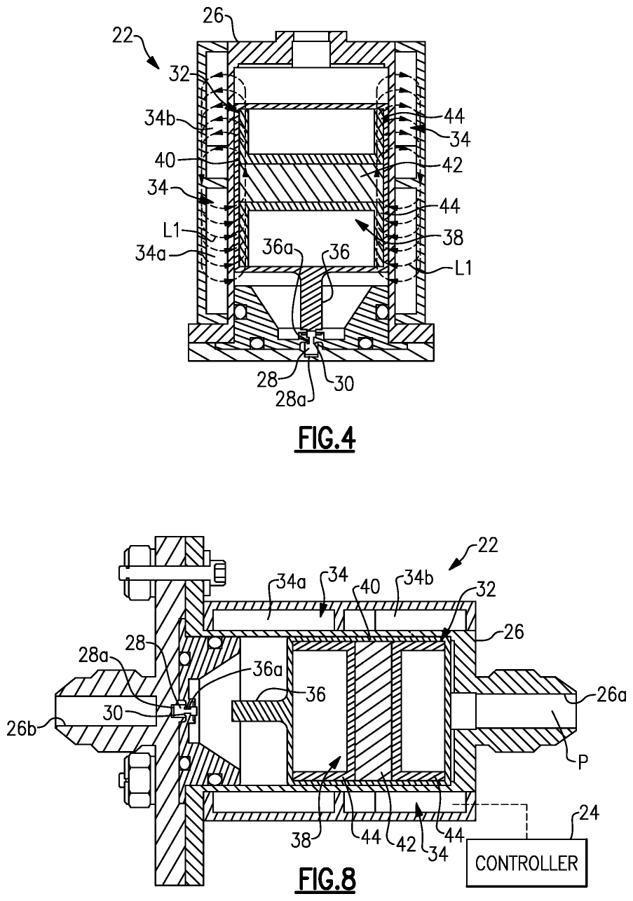

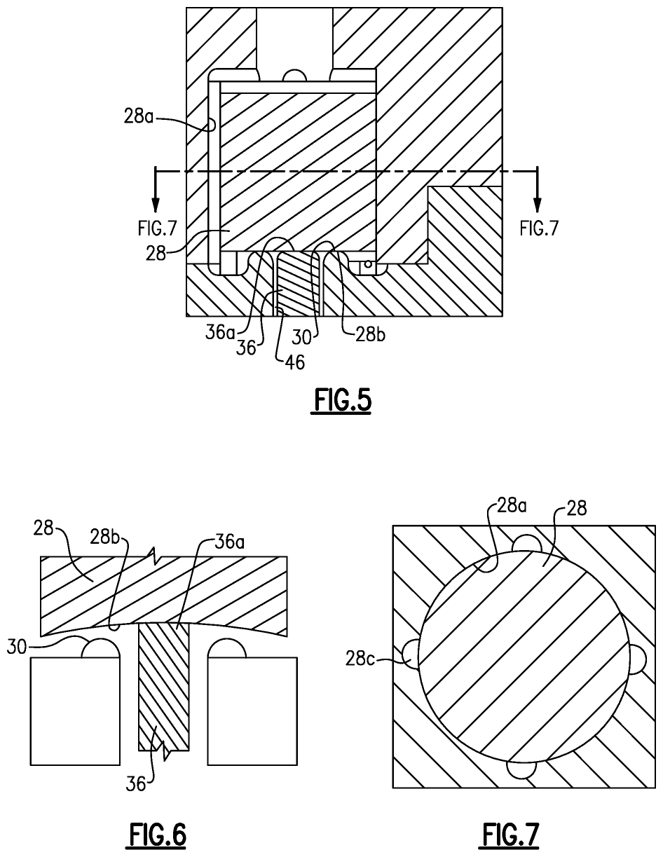

FIGS. 5 and 6 demonstrate operation of the seal 28. As shown in FIG. 5, the seal 28 is disposed in the seal cavity 28a. The seal 28 is trapped in the cavity 28a in a state of compression so as to substantially prevent translation of the seal 28 along the axial direction of the rod portion 36 of the armature 32 and provide a pre-load against the seal seat 30. In the closed state as in FIG. 5, a seal surface 28b bears against the seal seat 30, thereby preventing flow from passing. The tip 36a of the rod portion 36 may be in nominal contact with the seal 28 or spaced a short distance from the seal 28. There is little or no force applied by the rod portion 36 to the seal 28.

To open the seal 28, the controller 24 applies electric current to the electromagnet 34 in the first current direction. The electrical field of the first coil portion 34a interacts with the magnetic field of the permanent magnet 42 to magnetically push the armature 32 and thereby apply force on the seal 28 via the tip 36a of the rod portion 36. As shown in FIG. 6, the force applied to the seal 28 causes a portion of the seal 28 to deflect and thereby lift the seal surface 28b off of the seal seat 30. With the seal surface 28b lifted, fluid can then flow between the seal surface 28b and the seal seat 30, through flow channels 28c (FIG. 7) around the seal 28, and then out of the outlet 26b of the valve 22. The terms “push” and “pull” as used herein refer to the direction of applied force and movement of the armature 32, particularly the tip 36a of the rod portion 36, with respect to the electromagnet 34. A push tends to move the tip 36a away from the electromagnet 34 or in a direction out of the coil of the electromagnet 34, while a pull tends to move the tip 36a closer to the electromagnet 34 or in a direction into the coil of the electromagnet 34.

The amount of force applied can be modulated via the amount of electric current and selection of cross-sectional area of the tip 36a of the rod portion 36. The amount of deflection for flow by the seal 28 is a function of the amount of force applied and the properties of the material of the seal 28. The deflection provides a cross-sectional area for fluid flow by the seal 28. In some examples, a metering function is provided at a smaller cross-sectional area of the flow path at a location upstream of the seal 28, such as between the rod portion 36 and the walls of the orifice 46 (FIG. 5). Thus, the metering is established between metal components and does not change even if the cross-sectional area for flow at the seal 28 were to vary due to changes in the material of the seal 28 over time, which may in turn permit use of a wider range of materials for the seal 28.

To close the seal 28, the controller 24 applies electric current to the electromagnet 34 in the second current direction, i.e., reverses polarity. The electrical fields of the coil portions 34a/34b interact with the magnetic field of the permanent magnet 42 to pull the armature 32 and thereby remove the force that was applied on the seal 28. With the reduction in force, the portion of the seal 28 that had deflected to open the seal 28 then moves to thereby return to the closed state in which the seal interface 28b seats against the seal seat 30 so as to block fluid flow.

The valve 22 operates to open and close without the use of a spring. In valves that have a solenoid coil and a spring, the force is proportional to the square of the coil current, and regardless of the electric current direction the armature is attracted to move in only one direction-against the spring. In the valve 22, however, the force is linearly proportional to the electric current and the reversing of the electric current moves the armature 32 in opposite directions (push-pull). The push-pull ability eliminates the need for a spring, while the linear proportionality enables better control of the forces and thus enhanced valve performance.

In one example control scheme, the controller 24 executes an open command in which it applies a preset magnitude of electric current to the electromagnet 34 in the first current direction to open the seal 28. The electric current is held constant for a period of time to maintain the seal 28 in the open state and thereby provide fluid flow (e.g., to the combustor 14 to generate thrust). When fluid flow is no longer desired, the controller 24 executes a close command in which it applies a preset magnitude of electric current to the electromagnet 34 in the second current direction to close the seal 28. The electric current in the second direction is applied for a preset time period to remove the force from the seal 28. At the end of the preset time period, the electric current is turned off (zero current). For example, the preset time period is 10-100 milliseconds, after which the magnetic field of the permanent magnet 42 maintains the position of the armature 32 such that the seal 28 is in the closed state.

In a further example, the valve 22 also has a third state in which the armature 32 is latched, i.e. a latched state. In the latched state, the armature 32 is moved to its fully upstream position against the inlet side of the valve body 26. The permanent magnet 42 maintains the armature in this position with zero electric current in the electromagnet 34. At this location, the tip 36a of the rod portion 36 is substantially spaced apart from the seal 28. For instance, prior to operational opening and closing of the valve 22, the valve 22 may be subjected to vibrations that can cause chatter of the armature 32. The chatter can cause the tip 36a of the rod portion 36 to translate back-and-forth by a small distance. If the tip 36a is in contact with the seal 28 or is in close proximity to the seal 28, the chatter may cause the rod portion 36 to exert a transitory force on the seal 28. This may cause the seal 28 to momentarily open and permit a small amount of fluid to leak by. However, in the latched state, the armature 32, and thus the tip 36a, are spaced from the seal 28 by a distance that is substantially greater than the amplitude of the chatter vibration. As a result, even if there is chatter of the armature 32, it will not be able to contact the seal 28 or cause transitory leakage. Moreover, as the armature 32 is against the opening of the inlet 26a, the armature 32 can provide a sealing function to limit inflow of the fluid into the valve 22. The latched state is obtained by applying current in the second direction until the armature 32 contacts the inlet end of the body.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A valve comprising:
a valve body having a flow path;
a seal disposed in the flow path, the seal having a default closed state sealed against a seal seat so as to block flow through the flow path and an open state separated from the seal seat so as to permit flow through the flow path;
an armature disposed in the valve body and moveable with respect to the seal; and
an electromagnet that is configured to selectively receive an electric current in a first current direction or a second, opposite current direction, wherein when the electric current is in the first current direction the electromagnet actuates the armature to move the seal from the closed state to the open state and when the electric current is in the second current direction the electromagnet actuates the armature to move the seal from the open state to the closed state.

2. The valve as recited in claim 1, wherein the electromagnet includes first and second coil windings that are oppositely wound.

3. The valve as recited in claim 1, wherein the armature includes a rod portion, a yoke comprised of a permanent magnet and a keeper that surrounds the permanent magnet, and a shell that encases the yoke.

4. The valve as recited in claim 3, wherein the rod portion has a tip that is in contact with the seal.

5. The valve as recited in claim 3, wherein the shell is non-ferromagnetic and is formed of a titanium-based alloy.

6. The valve as recited in claim 5 wherein the seal is an elastomer.

7. The valve as recited in claim 3, wherein the shell is a material selected from the group consisting of titanium-based alloy, aluminum-based alloy, and polymer.

8. The valve as recited in claim 3, wherein when the electric current is in the first current direction the electromagnet magnetically pushes the rod portion to apply force on the seal and thereby move the seal from the closed state to the open state and when the electric current is applied in the second current direction the electromagnet magnetically pulls the rod portion to remove the force on the seal and thereby move the seal from the open state to the closed state.

9. The valve as recited in claim 8, wherein the force causes a portion of the seal to deflect and lift off of the seal seat so as to open the flow through the flow path.

10. The valve as recited in claim 1, further comprising a controller connected with the electromagnet and configured to selectively apply the electric current in the first direction or the second direction.

11. The valve as recited in claim 10, wherein the controller is configured to apply the electric current in the second current direction for a preset amount of time to move the seal from the open state to the closed state.

12. A valve comprising:
a valve body having a flow path;
a seal disposed in the flow path, the seal having a default closed state sealed against a seal seat so as to block flow through the flow path and an open state in which the seal permits flow through the flow path;
an armature disposed in the valve body; and
an electromagnet configured to magnetically push the armature to apply force on the seal and thereby move the seal from the closed state to the open state, the force causing a portion of the seal to deflect and thereby separate from the seal seat so as to open the flow through the flow path.

13. The valve as recited in claim 12, wherein the electromagnet includes first and second coil windings that are oppositely wound, and the armature includes a rod portion, a yoke comprised of a permanent magnet and a keeper that surrounds the permanent magnet, and a shell that encases the yoke.

14. The valve as recited in claim 13, wherein the rod portion has a distal tip that is in contact with the seal and the seal is an elastomer.

15. The valve as recited in claim 13, wherein the shell is non-ferromagnetic and is formed of a titanium-based alloy.

16. The valve as recited in claim 13, wherein the shell is a material selected from the group consisting of titanium-based alloy, aluminum-based alloy, and polymer.

17. The valve as recited in claim 13, wherein the electromagnet is configured to selectively receive electric current in a first current direction or a second, opposite current direction, wherein when the electric current is in the first current direction the electromagnet magnetically pushes the armature to apply the force on the seal and when the electric current is in the second current direction the electromagnet magnetically pulls the armature to reduce the force on the seal, the reduction in force causing the portion of the seal to move and thereby seat on the seal seat so as to close the flow through the flow path.

18. A rocket motor comprising:
a propellant tank holding propellant;
a combustor;
a nozzle attached with the combustor;
a supply line fluidly connecting the propellant tank and the combustor; and
a valve situated in the supply line, the valve including:
a valve body having a flow path connecting the inlet and the outlet,
a seal disposed in the flow path, the seal having a default closed state sealed against
a seal seat so as to block flow through the flow path and an open state moved from the seal seat so as to permit flow through the flow path,
an armature disposed in the valve body and moveable with respect to the seal, and
an electromagnet that is configured to selectively receive an electric current in a first current direction or a second, opposite current direction, wherein when the electric current is in the first current direction the electromagnet actuates the armature to move the seal from the closed state to the open state and when the electric current is in the second current direction the electromagnet actuates the armature to move the seal from the open state to the closed state.

19. The rocket motor as recited in claim 18, wherein the electromagnet includes first and second coil windings that are oppositely wound, the armature includes a rod portion, a yoke comprised of a permanent magnet and a keeper that surrounds the permanent magnet, and a shell that encases the yoke, and the shell is non-ferromagnetic and is formed of a titanium-based alloy.
